(19) United States
(12) Patent Application Publication
(10) Pub. No.: US 2015/0341308 A1
(43) Pub. Date: Nov. 26, 2015

(54) mDNS REPLICATOR USING DEVICE DISCOVERY

(71) Applicants: Toshiba Tec Kabushiki Kaisha, Tokyo (JP); Kabushiki Kaisha Toshiba, Tokyo (JP)

(72) Inventor: Matthew Hansen, Mount Horeb, WI (US)

(21) Appl. No.: 14/286,763

(22) Filed: May 23, 2014

(51) Int. Cl. H04L 29/12; H04L 29/08

(52) U.S. Cl. CPC H04L 61/20; H04L 67/10

(57) ABSTRACT

System, apparatus, and methods for replicating mDNS using unicast discovery are disclosed. A series of mDNS discovery operations may be performed on a series of Internet protocol subnets of which a server performing the series of mDNS discovery operations is not a part. Device data may be received from a first at least one multifunction peripheral on the series of Internet protocol subnets, the device data identifying at least one service that the first at least one multifunction peripheral is capable of performing. A domain name server may be updated with the Internet protocol address of the first at least one multifunction peripheral and the at least one service.

### BACKGROUND

1. Field

This disclosure relates to performing document processing operations using public and private data sources and output locations.

2. Description of the Related Art

A multifunction peripheral (MFP) is a type of document processing device which is an integrated device providing at least two document processing functions, such as print, copy, scan and fax. In a document processing function, an input document (electronic or physical) is used to automatically produce a new output document (electronic or physical).

Documents may be physically or logically divided into pages. A physical document is paper or other physical media bearing information which is readable unaided by the typical human eye. An electronic document is any electronic media content (other than a computer program or a system file) that is intended to be used in either an electronic form or as printed output. Electronic documents may consist of a single data file, or an associated collection of data files which together are a unitary whole. Electronic documents will be referred to further herein as documents, unless the context requires some discussion of physical documents which will be referred to by that name specifically.

In printing, the MFP automatically produces a physical document from an electronic document. In copying, the MFP automatically produces a physical document from a physical document. In scanning, the MFP automatically produces an electronic document from a physical document. In faxing, the MFP automatically transmits via fax an electronic document from an input physical document which the MFP has also scanned or from an input electronic document which the MFP has converted to a fax format.

MFPs are often incorporated into corporate or other organization's networks which also include various other workstations, servers and peripherals. An MFP may also provide remote document processing services to external or network devices.

Discovery of MFPs on networks has become a more difficult task in an era in which mobile devices are prevalent. Virtually every employee has one or more mobile devices at his or her disposal. Mobile phones and tablets are common both for personal and for business use. Performing document processing operations from these devices is convenient and can increase productivity of employees, but ensuring that mobile devices have access to MFPs and can find MFPs wireless on a local area network, particularly a local area network that includes several subnets and may include one or more wireless networks is difficult.

Most device discovery protocols were designed with individual home use or use on small subnets in mind. As a result, these discovery protocols do not function optimally for mixed networks of many subnets.

### DESCRIPTION OF THE DRAWINGS

FIG. 1 is a diagram of an MFP system.

FIG. 2 is a block diagram of an MFP.

FIG. 3 is a block diagram of a computing device.

FIG. 4 is a block diagram of a software system for an MFP.

FIG. 5 is a block diagram of a mDNS discovery software system.

FIG. 6 is a flowchart showing an mDNS discovery process from the perspective of an mDNS daemon server.

FIG. 7 is a flowchart showing an mDNS discovery process from the perspective of a mobile device.

Throughout this description, elements appearing in figures are assigned three-digit reference designators, where the most significant digit is the figure number where the element is introduced, and the two least significant digits are specific to the element. An element that is not described in conjunction with a figure may be presumed to have the same characteristics and function as a previously-described element having the same reference designator.

### DETAILED DESCRIPTION

In order to address the complications associated particularly with mobile device detection of available multifunction peripherals, network administrators have resorted to periodically updating a domain name server (DNS) with the Internet protocol addresses associated with MFPs available on a given network. These DNS entries may also indicate the types of services that an MFP is capable of performing and the ports that they “listen” for which service(s).

However, this process is cumbersome, involves long strings of numbers and is prone to error or neglect. As a result, the MFPs available to one or more mobile devices searching for devices may be limited only to those most-recently updated in the DNS servers or appearing in the same Internet protocol subnet (and, therefore, detectable by typical discovery processes). This is undesirable because in many cases, the MFP physically nearest to a mobile user may not be on the same subnet and may have only recently been installed.

As a result, a system for ensuring that all MFPs, regardless of the subnet on which they appear, show up in a network's DNS servers is desirable. In this way, all MFPs, those on a local subnet and anywhere on a network will be visible to mobile devices (and any other devices) seeking MFPs to perform various MFP functions.

Description of Apparatus

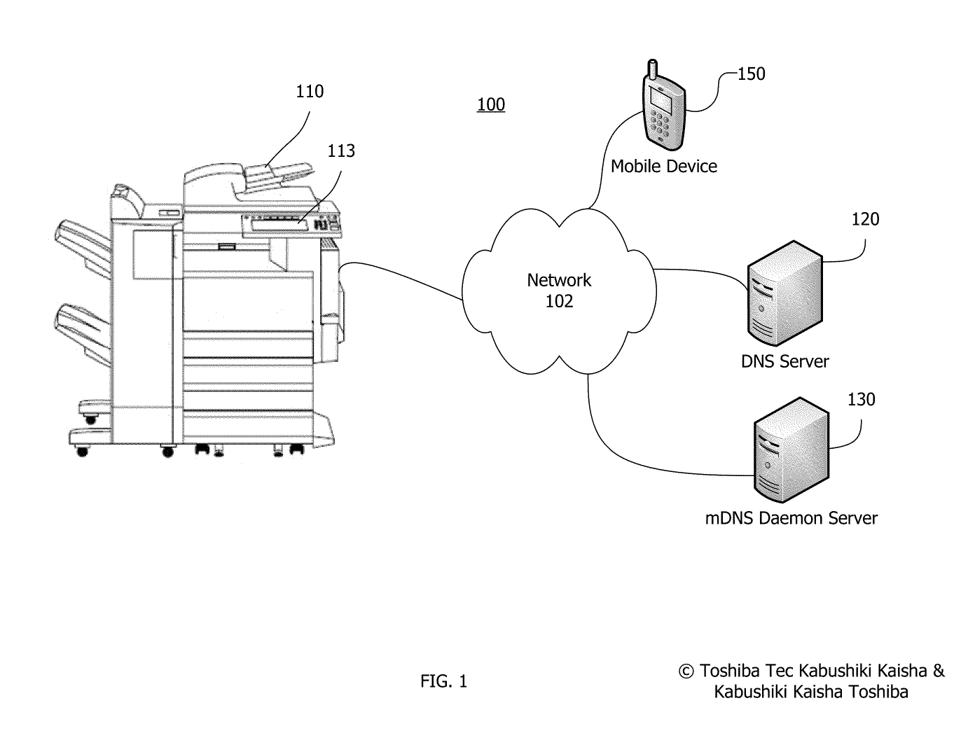

Referring now to FIG. 1 there is shown an MFP system 100. The MFP system 100 includes an MFP 110, a DNS server 120, a multicast DNS (mDNS) daemon server 130, and a mobile device 150, all interconnected by a network 102. The MFP system 100 may be implemented in a distributed computing environment and interconnected by the network 102. An MFP system 100 may include more MFPs, more or fewer servers, and more than one mobile device.

The network 102 may be or include a local area network, a wide area network, a personal area network, a mobile or telephone network, the Internet, an intranet, or any combination of these. The network 102 may have physical layers and transport layers according to IEEE 802.11, Ethernet or other wireless or wire-based communication standards and protocols such as WiMAX®, Bluetooth®, mobile telephone and data protocols, the public switched telephone network, a proprietary communications network, infrared, and optical.

The MFP 110 may be equipped to receive portable storage media such as USB drives. The MFP 110 includes a user interface subsystem 113, which communicates information to and receives selections from users. The user interface subsystem 113 has a user output device for displaying graphical elements, text data or images to a user and a user input device for receiving user inputs. The user interface subsystem 113 may include a touchscreen, LCD display, touch-panel, alpha-numeric keypad and/or an associated thin client through which a user may interact directly with the MFP 110.

The DNS server 120 is software operating on a server computer connected to the network 102. The DNS server 120 is responsible for “naming” servers and other devices within a network with convenient names. The DNS system is used, on a much larger scale, for translating names like “www.google.com” into an Internet protocol address associated with http requests directed to that domain name.

The DNS server 120 internal to a network is the first place devices on that network look to resolve network shorthand for network locations or to determine what services and devices are available within a network. If the local DNS server, such as DNS server 120, does not have any entry, then another DNS server outside of the network may be consulted. This continues up the chain as far as necessary to resolve an address or other shorthand name for network locations and resources.

The DNS server 120 performs those functions for a portion of the network 102 that includes the MFP and the mobile device 150. This network portion may be, for example, a private network that serves a business or an entity. The private network may be, for example, the local area network (LAN) of a business or may be several LANs connected by VPN services or over longer distances by a WAN. The network hierarchy is largely determined by the network administrator. The DNS server 120 is a DNS server for the private network, separate from the DNS system employed by the Internet at large.

The mDNS daemon server 130 is software operating on a server computer connected to the network 102. The mDNS daemon server 130 is shown as distinct from the DNS server 120, but may actually operate on the same physical server computer, on one or more MFPs, such as MFP 110, or on another computer operating on the network 102. The mDNS daemon server 130 periodically polls (or listens on) all Internet protocol subnets in order to “discover” devices available on the network made up of the subnets.

This process may involve listening for multicast or unicast DNS broadcasts announcing the presence of a device (such as an MFP) on particular network ports. This process may involve actively multicasting requests for responses from devices (such as MFPs) on particular ports. These responses or these broadcasts may indicate a network name for a particular device and may further indicate the type of functionality provided by each device, such as black and white printing, color printing, scanning, facsimile, document email, cloud or network storage, and other document processing operations.

The mobile device 150 is a mobile or handheld PC, a tablet or smart phone, a feature phone, smart watch, or other similar device. The mobile device 150 is representative of one or more end-user devices and in some cases may not be a part of the overall MFP system 100.

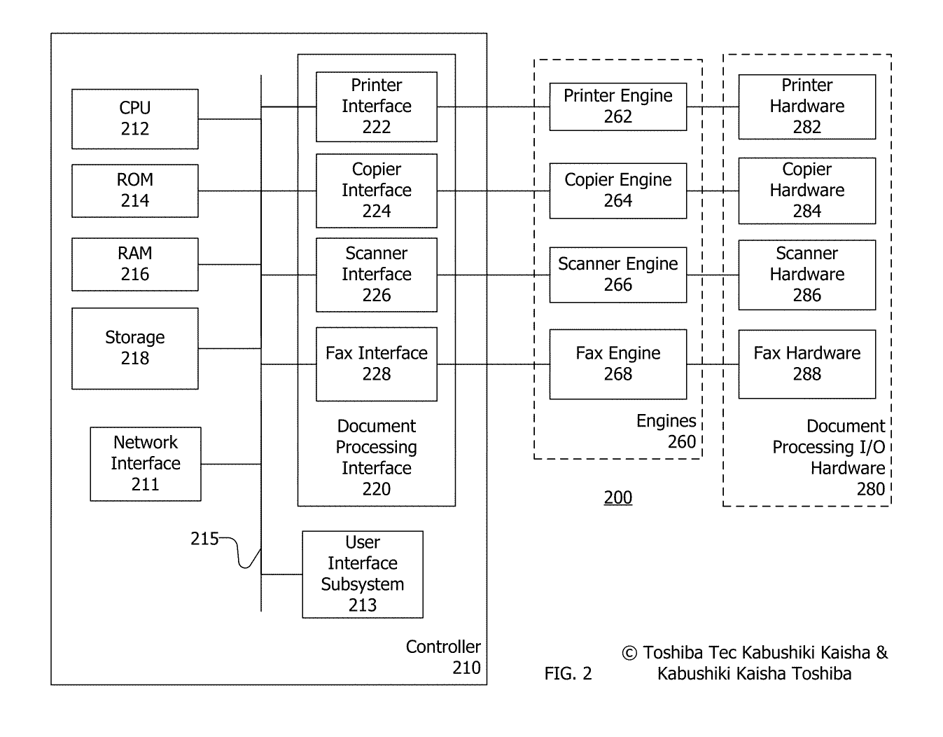

Turning now to FIG. 2 there is shown a block diagram of an MFP 200 which may be the MFP 110 (FIG. 1). The MFP 200 includes a controller 210, engines 260 and document processing I/O hardware 280. The controller 210 includes a CPU 212, a ROM 214, a RAM 216, a storage 218, a network interface 211, a bus 215, a user interface subsystem 213 and a document processing interface 220.

As shown in FIG. 2 there are corresponding components within the document processing interface 220, the engines 260 and the document processing I/O hardware 280, and the components are respectively communicative with one another. The document processing interface 220 has a printer interface 222, a copier interface 224, a scanner interface 226 and a fax interface 228. The engines 260 include a printer engine 262, a copier engine 264, a scanner engine 266 and a fax engine 268. The document processing I/O hardware 280 includes printer hardware 282, copier hardware 284, scanner hardware 286 and fax hardware 288.

The MFP 200 is configured for printing, copying, scanning and faxing. However, an MFP may be configured to provide other document processing functions, and, as per the definition, as few as two document processing functions.

The CPU 212 may be a central processor unit or multiple processors working in concert with one another. The CPU 212 carries out the operations necessary to implement the functions provided by the MFP 200. The processing of the CPU 212 may be performed by a remote processor or distributed processor or processors available to the MFP 200. For example, some or all of the functions provided by the MFP 200 may be performed by a server or thin client associated with the MFP 200, and these devices may utilize local resources (e.g., RAM), remote resources (e.g., bulk storage), and resources shared with the MFP 200.

The ROM 214 provides non-volatile storage and may be used for static or fixed data or instructions, such as BIOS functions, system functions, system configuration data, and other routines or data used for operation of the MFP 200.

The RAM 216 may be DRAM, SRAM or other addressable memory, and may be used as a storage area for data instructions associated with applications and data handling by the CPU 212.

The storage 218 provides volatile, bulk or long term storage of data associated with the MFP 200, and may be or include disk, optical, tape or solid state. The three storage components, ROM 214, RAM 216 and storage 218 may be combined or distributed in other ways, and may be implemented through SAN, NAS, cloud or other storage systems.

The network interface 211 interfaces the MFP 200 to a network, such as the network 102 (FIG. 1), allowing the MFP 200 to communicate with other devices.

The bus 215 enables data communication between devices and systems within the MFP 200. The bus 215 may conform to the PCI Express or other bus standard.

While in operation, the MFP 200 may operate substantially autonomously. However, the MFP 200 may be controlled from and provide output to the user interface subsystem 213, which may be the user interface subsystem 113 (FIG. 1).

The document processing interface 220 may be capable of handling multiple types of document processing operations and therefore may incorporate a plurality of interfaces 222, 224, 226 and 228. The printer interface 222, copier interface 224, scanner interface 226, and fax interface 228 are examples of document processing interfaces. The interfaces 222, 224, 226 and 228 may be software or firmware.

Each of the printer engine 262, copier engine 264, scanner engine 266 and fax engine 268 interact with associated printer hardware 282, copier hardware 284, scanner hardware 286 and facsimile hardware 288, respectively, in order to complete the respective document processing functions.

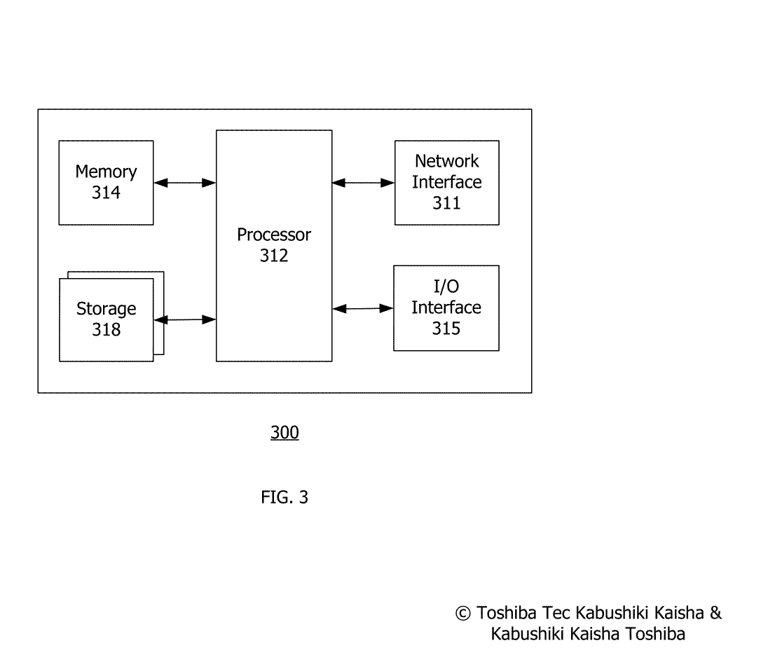

Turning now to FIG. 3 there is shown a computing device 300, which is representative of the server computers, client devices, mobile devices and other computing devices discussed herein. The controller 210 (FIG. 2) may also, in whole or in part, incorporate a general purpose computer like the computing device 300. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 has a processor 312 coupled to a memory 314, storage 318, a network interface 311 and an I/O interface 315. The processor may be or include one or more microprocessors and, application specific integrated circuits (ASICs).

The memory 314 may be or include RAM, ROM, DRAM, SRAM and MRAM, and may include firmware, such as static data or fixed instructions, BIOS, system functions, configuration data, and other routines used during the operation of the computing device 300 and processor 312. The memory 314 also provides a storage area for data and instructions associated with applications and data handled by the processor 312.

The storage 318 provides non-volatile, bulk or long term storage of data or instructions in the computing device 300. The storage 318 may take the form of a disk, tape, CD, DVD, or other reasonably high capacity addressable or serial storage medium. Multiple storage devices may be provided or available to the computing device 300. Some of these storage devices may be external to the computing device 300, such as network storage or cloud-based storage.

The network interface 311 includes an interface to a network such as network 102 (FIG. 1).

The I/O interface 315 interfaces the processor 312 to peripherals (not shown) such as displays, keyboards and USB devices.

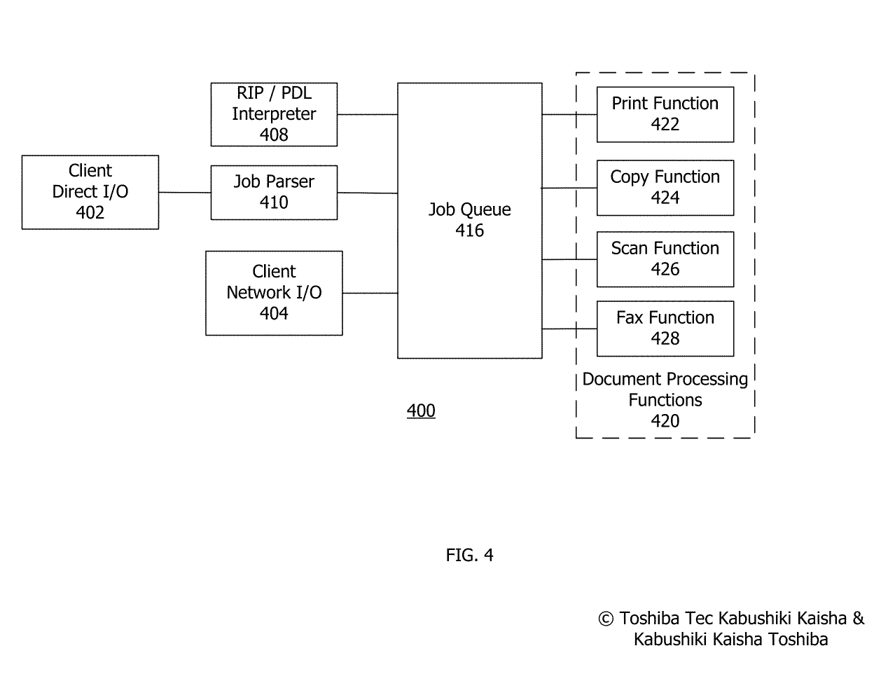

Turning now to FIG. 4 there is shown a block diagram of a software system 400 of an MFP which may operate on the controller 210. The system 400 includes client direct I/O 402, client network I/O 404, a RIP/PDL interpreter 408, a job parser 410, a job queue 416, a series of document processing functions 420 including a print function 422, a copy function 424, a scan function 426 and a fax function 428.

The client direct I/O 402 and the client network I/O 404 provide input and output to the MFP controller. The client direct I/O 402 is for the user interface on the MFP (e.g., user interface subsystem 113), and the client network I/O 404 is for user interfaces over the network. This input and output may include documents for printing or faxing or parameters for MFP functions. In addition, the input and output may include control of other operations of the MFP. The network-based access via the client network I/O 404 may be accomplished using HTTP, FTP, UDP, electronic mail TELNET or other network communication protocols.

The RIP/PDL interpreter 408 transforms PDL-encoded documents received by the MFP into raster images or other forms suitable for use in MFP functions and output by the MFP. The RIP/PDL interpreter 408 processes the document and adds the resulting output to the job queue 416 to be output by the MFP.

The job parser 410 interprets a received document and relays it to the job queue 416 for handling by the MFP. The job parser 410 may perform functions of interpreting data received so as to distinguish requests for operations from documents and operational parameters or other elements of a document processing request.

The job queue 416 stores a series of jobs for completion using the document processing functions 420. Various image forms, such as bitmap, page description language or vector format may be relayed to the job queue 416 from the scan function 426 for handling. The job queue 416 is a temporary repository for all document processing operations requested by a user, whether those operations are received via the job parser 410, the client direct I/O 402 or the client network I/O 404. The job queue 416 and associated software is responsible for determining the order in which print, copy, scan and facsimile functions are carried out. These may be executed in the order in which they are received, or may be influenced by the user, instructions received along with the various jobs or in other ways so as to be executed in different orders or in sequential or simultaneous steps. Information such as job control, status data, or electronic document data may be exchanged between the job queue 416 and users or external reporting systems.

The job queue 416 may also communicate with the job parser 410 in order to receive PDL files from the client direct I/O 402. The client direct I/O 402 may include printing, fax transmission or other input of a document for handling by the system 400.

The print function 422 enables the MFP to print documents and implements each of the various functions related to that process. These include stapling, collating, hole punching, and similar functions. The copy function 424 enables the MFP to perform copy operations and all related functions such as multiple copies, collating, 2 to 1 page copying or 1 to 2 page copying and similar functions. Similarly, the scan function 426 enables the MFP to scan and to perform all related functions such as shrinking scanned documents, storing the documents on a network or emailing those documents to an email address. The fax function 428 enables the MFP to perform facsimile operations and all related functions such as multiple number fax or auto-redial or network-enabled facsimile.

Some or all of the document processing functions 420 may be implemented on a client computer, such as a personal computer or thin client. The user interface for some or all document processing functions may be provided locally by the MFP's user interface subsystem though the document processing function is executed by a computing device separate from but associated with the MFP.

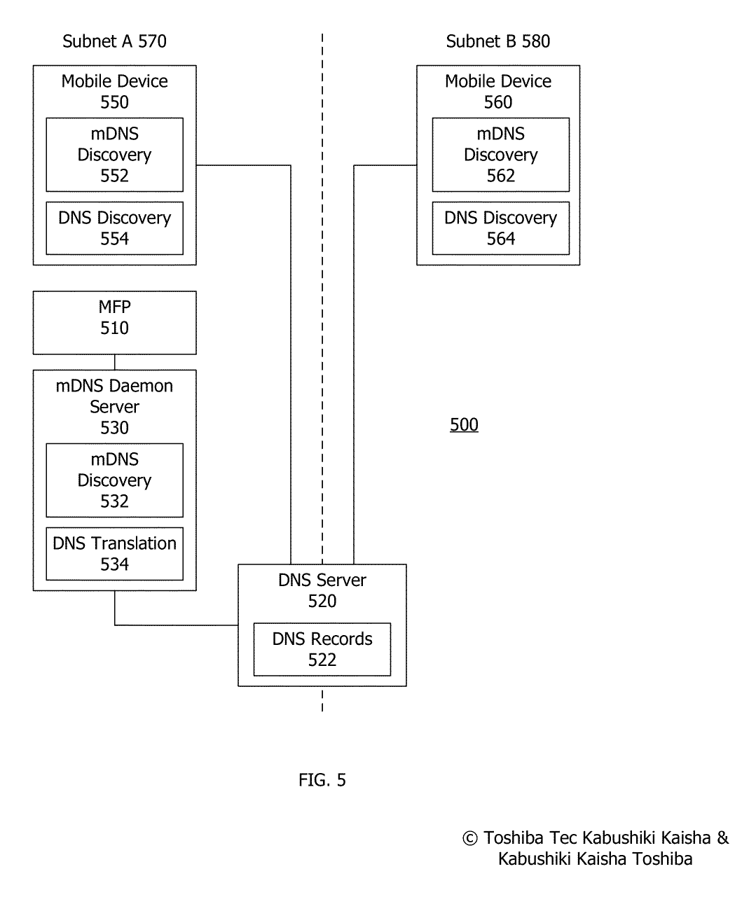

Turning now to FIG. 5 a block diagram of a mDNS discovery software system 500 is shown. The system includes at least two subnets A 570 and B 580, divided by a dashed line. Subnet A 570 and B 580 are representative of two separate Internet protocol subnets, such as, for example, 10.1.1.x and 10.1.2.x. The different numbers in the second-to-last triplet indicates that it is a distinct subnet.

In Internet protocol, IP addresses are allocated in four triplet sets (six in IP version six) of numbers from 0 to 255. So, IP addresses in the 10.1.1.x subnet range from 10.1.1.0 to 10.1.1.255. The IP addresses in the 10.1.2.x subnet range from 101.1.2.0 to 10.1.2.255. Dependent upon the network architecture, IP addresses in 10.1.x.x may be considered a distinct subnet from those in 10.2.x.x in much a similar way. The allocation of subnets and the number of IP addresses used within an organization is largely dependent upon the size of the organization and the number of individual computing devices connected to a particular network. Here, subnet A 570 and subnet B 580 are distinct subnets separated by at least one digit in the second-to-last triplet, but may be separated by more.

MFP 510, which may be the same MFP 110 from FIG. 1, is on subnet A 570 along with mDNS daemon server 530 and mobile device 550. These may be the mDNS daemon server 130 and mobile device 150 of FIG. 1. The mobile device 550 may be, for example, a mobile phone connected to a wireless access point within the network and further within subnet A 570.

The DNS server 520 is shown as straddling both subnet a 570 and subnet B 580, because the DNS server 520 is responsible for all DNS internal to the network operated by this entity. This may be only these two subnets A 570 and B 580 or may include many other subnets. Regardless of the subnet, DNS server 520 is available to any device on any subnet served by the DNS server 520 in order to resolve DNS requests.

Mobile device 560 is shown on subnet B 580, separate from MFP 510 and mDNS daemon server 530.

Both mobile device 550 and mobile device 560 have mDNS discovery processes 552 and 562 and DNS discovery processes 554, 564. The mDNS discovery processes 552 (informally known as “Bonjour” services) are capable of generating a multicast query to a subnet, such as subnet B 580, to request responses from devices within that subnet. The multicast query may have a designated port and may be directed only to devices capable of performing a specific function. Devices available on that subnet that are listening on that port will, then, respond to that multicast query indicating that they are available. In this way, devices on a subnet, such as subnet B 580, that are capable of performing a function may be discovered.

However, as can be seen in FIG. 5, subnet B 580 does not include any multifunction peripherals. The only MFP is MFP 510 in subnet A 570. Accordingly, no devices will respond to any such request by mobile device 560 and none will be discovered using the mDNS discovery process 562.

Mobile devices 550 and 560 also have DNS discovery processes 554 and 564. These processes rely on the typical DNS server to obtain information about servers and other devices available on a network. However, DNS servers generally rely upon manual entry (or automatic IP allocation without any additional information) of devices present. Thus, without intervention, the DNS server 520 will only know that there are a plurality of devices of indeterminate type connected to the network. This type of information is virtually unusable for device discovery.

However, DNS discovery processes 554, and 564 can be directed to the DNS server 520 to request devices of a defined type or that provide a known service if the appropriate ports are known or the appropriate service types have been inputted into the DNS server 520. DNS discovery processes 554 and 564 performs these discovery processes. If the DNS records 522 on the DNS server 520 have the desired information, it can be returned to the requesting mobile device 550 or 560.

mDNS daemon server 530 includes mDNS discovery 532 and DNS translation 534. mDNS discovery 532 performs more than the typical subnet-only mDNS discovery processes, like mDNS discovery processes 552 and 562. Instead, it actively iterates multicast discovery requests through subnets known to include (or identified by administrators as potentially including) MFPs or other devices for which relevant DNS entries are desirable. As it iterates, it notes the IP addresses, responses, and capabilities of devices that respond to its multicast discovery requests.

The DNS translation 534 automatically transforms the discovered data into a form suitable for entry in a DNS database and inserts that data into the DNS records 522 on the DNS server 520. The mDNS daemon server 530 is shown as separate from the DNS server 520 but may, in fact, operate on the same physical device or upon one or more MFPs, such as MFP 510.

Once the mDNS data obtained through mDNS discovery 532 for each relevant subnet is added to the DNS records 522, by the DNS translation 534, responses from the DNS server 520 to DNS queries by mobile devices 550 and 560 will include all known devices, such as MFP 510, regardless of the subnet from which the request originated. Mobile devices, such as mobile device 560 may still perform mDNS discovery process 562 when performing device discovery in order to access any devices on the relevant subnet that may be newly-added. Such devices may not yet appear in the DNS server 520 DNS records 522.

Description of Processes

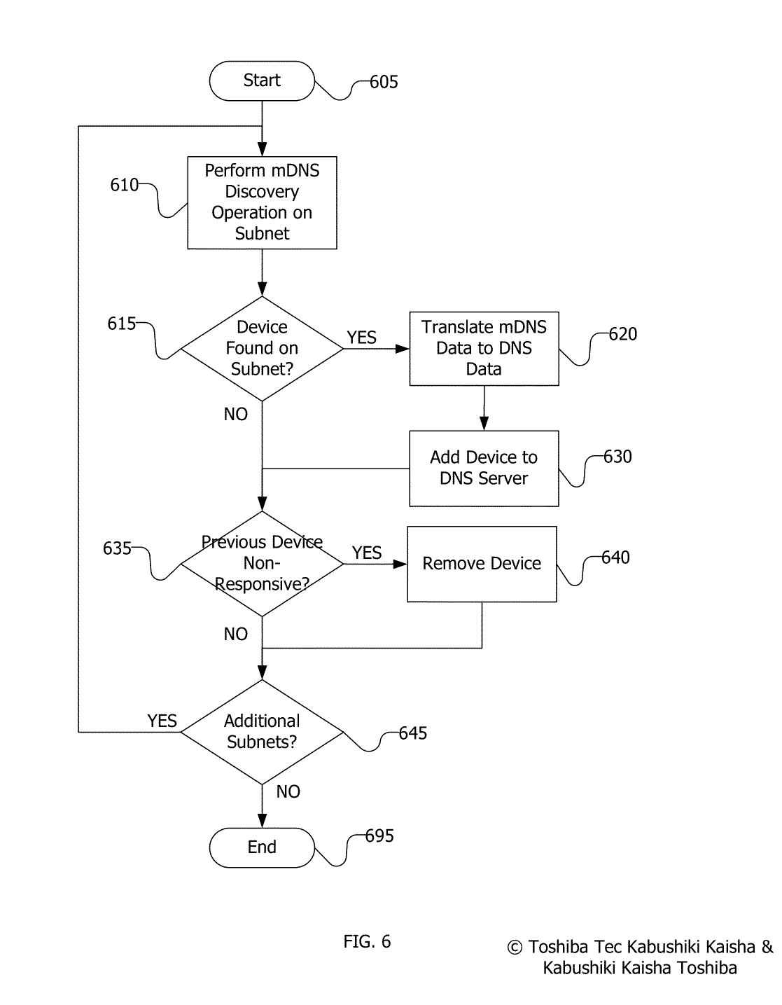

Turning to FIG. 6, a flowchart showing an mDNS discovery process from the perspective of an mDNS daemon server is shown. The process begins at start 605 and ends at end 695, but may take place many times over. In fact, the process may repeat periodically over the course of a day at predetermined intervals.

After the start 605, the mDNS daemon server performs discovery operation on a subnet 610. This subnet may be selected from a list stored on the mDNS daemon server that identifies subnets that may include or are known to include relevant devices, such as MFPs. This discovery operation may be an mDNS multicast request to any devices listening on a relevant port and awaiting responses on a specific port to that mDNS multicast request. Alternatively, the devices themselves may periodically and/or automatically multicast availability on a known port and the mDNS daemon server may passively listen for those broadcasts.

Next, a determination is made whether a device was found on that subnet at 615. This determination is made based upon whether a device (or more than one device) responded to the discovery operation. Alternatively, this determination may be made without any active discovery operation and may merely be a determination that a device itself multicast availability.

If a device is found on the subnet (“yes” at 615), then the mDNS data obtained from that device is translated into DNS data at 620. That translation process primarily involves formatting the data into a form suitable for entry into the DNS records of the DNS server. Once translation is complete, the device (DNS formatted data associated with the device) is entered into the DNS server at 630. After this data is entered into the DNS server at 630, subsequent requests to the server will result in that device being returned as a possibility for the requested function (for example, printing).

Next, or if no devices were found on a subnet (“no” at 615), a determination may be made whether a previously-responsive device is now non-responsive at 635. This may occur, for example, when a device is removed from a network or is permanently or temporarily non-functional. If a previous device is non-responsive (“yes” at 635), then that device's data is removed from the DNS server at 640.

Next, or if no previous devices were found to be non-responsive (“no” at 635), then a determination is made by the mDNS daemon server whether additional subnets are to be searched for devices at 645. If so (“yes” at 645), then the process begins with a different subnet. In this way, device discovery may be conducted on many subnets before the process ends. If not (“no” at 645), then the process ends at 695.

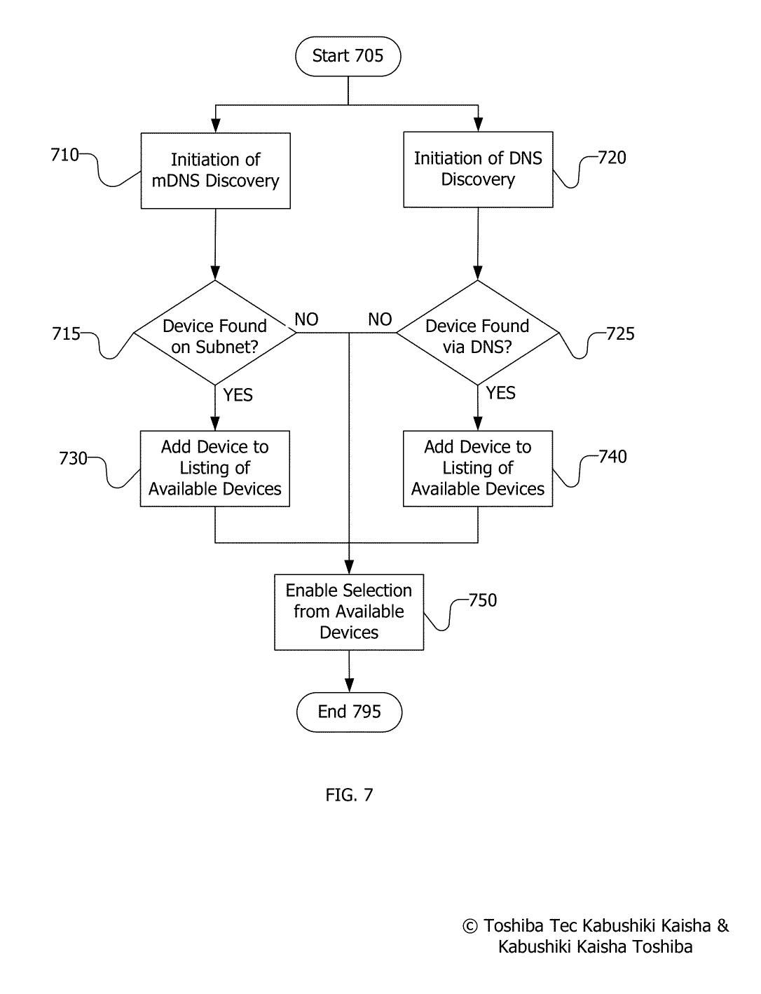

FIG. 7 shows a flowchart showing an mDNS discovery process from the perspective of a mobile device. The process begins at start 705 and ends at end 795. The mDNS discovery process may be repeated each time the mobile device needs to access a printer, scanner, or other network resource.

The process begins after start 705 with initiation of mDNS discovery at 710 and a DNS discovery at 720. The mDNS and DMS discovery may be performed concurrently, as shown, or sequentially in any order.

mDNS discovery, as discussed above with reference to FIG. 5, is a subnet-bound process of multicasting a request for devices that may serve a particular function. This broadcast may, for example, use a specific port known to be used for a specific function or by specific device types. The mDNS discovery is limited to only the subnet of which the device initiating the mDNS discovery operation is a part.

The DNS discovery at 720 is a request to the network's DNS server to provide a listing of devices serving a particular function, for example listening on a port, designated for a function, or capable of accepting particular types of data. This listing may be a listing of printers, multifunction devices, or a listing of other device types.

If a device is found on the subnet by the mDNS discovery (“yes” at 715), then that device or those devices are added to a listing of available devices for the mobile device performing this process at 730. Similarly, if a device is found via DNS (“yes” at 725), then that device or those devices are added to the listing of available devices for the mobile device performing this process at 740.

Finally, selection of a device (such as an MFP) from a listing of available devices is enabled at 750. This process enables a mobile device to select a device for, for example, performing a document processing operation such as printing, scanning, facsimile, and other similar operations. Although the mobile device may perform other functions, this is the end 795 of the mDNS discovery process.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for replicating mDNS discovery comprising:
performing a series of mDNS discovery operations on a series of Internet protocol subnets of which a server performing the series of mDNS discovery operations is not a part;
receiving device data from a first at least one multifunction peripheral on the series of Internet protocol subnets, the device data identifying at least one service that the first at least one multifunction peripheral is capable of performing; and
updating a domain name server with the Internet protocol address of the first at least one multifunction peripheral and the at least one service.

2. The method of claim 1 further comprising:
generating a mDNS discovery request;
generating a DNS discovery request;
receiving a response to the mDNS discovery request identifying a second at least one multifunction peripheral from a first Internet protocol subnet from which the mDNS discovery was sent;
receiving a response to the DNS discovery request identifying a third at least one multifunction peripheral on a second Internet protocol subnet different from the first Internet protocol subnet from which the DNS discovery was sent; and
adding the second at least one multifunction peripheral and the third at least one multifunction peripheral to a listing of available multifunction peripherals.

3. The method of claim 2 further comprising requesting a document processing operation on a selected multifunction peripheral selected from the listing of available multifunction peripherals.

4. The method of claim 1 further comprising periodically repeating the process at predetermined intervals.

5. The method of claim 1 wherein the updating further comprises removing multifunction peripherals from the domain name server that are no longer responsive to discovery requests.

6. The method of claim 1 wherein the series of mDNS discovery operations are at least in part passive and include listening for multifunction peripherals to broadcast their availability on each of the series of Internet protocol subnets.

7. The method of claim 1 further comprising translating the device data into data suitable for storage in the domain name server.

8. A mDNS discovery system comprising a server for:
performing a series of mDNS discovery operations on a series of Internet protocol subnets of which a server performing the series of mDNS discovery operations is not a part;
receiving device data from a first at least one multifunction peripheral on the series of Internet protocol subnets, the device data identifying at least one service that the first at least one multifunction peripheral is capable of performing; and
updating a domain name server with the Internet protocol address of the first at least one multifunction peripheral and the at least one service.

9. The mDNS unicast discovery system of claim 8 further comprising a mobile device for:
generating a mDNS unicast discovery request;
generating a DNS discovery request;
receiving a response to the mDNS discovery request identifying a second at least one multifunction peripheral from a first Internet protocol subnet from which the mDNS discovery was sent;
receiving a response to the DNS discovery request identifying a third at least one multifunction peripheral on a second Internet protocol subnet different from the first Internet protocol subnet from which the DNS discovery was sent; and
adding the second at least one multifunction peripheral and the third at least one multifunction peripheral to a listing of available multifunction peripherals.

10. The mDNS discovery system of claim 9 wherein the mobile device is further for requesting a document processing operation on one of the second and third multifunction peripheral.

11. The mDNS discovery system of claim 8 wherein the server periodically repeats the process at predetermined intervals.

12. The mDNS discovery system of claim 8 wherein the updating further comprises removing multifunction peripherals from the domain name server that are no longer responsive to discovery requests.

13. The mDNS discovery system of claim 8 wherein the series of mDNS discovery operations are at least in part passive and include listening for multifunction peripherals to broadcast their availability on each of the series of Internet protocol subnets.

14. The mDNS discovery system of claim 8 wherein the server is further for translating the device data into data suitable for storage in the domain name server.

15. Apparatus comprising a storage medium storing instructions which when executed by a processor will cause the processor to replicate mDNS discovery using unicast discovery, the instructions for:
performing a series of mDNS discovery operations on a series of Internet protocol subnets of which a server performing the series of mDNS discovery operations is not a part;
receiving device data from a first at least one multifunction peripheral on the series of Internet protocol subnets, the device data identifying at least one service that the first at least one multifunction peripheral is capable of performing; and
updating a domain name server with the Internet protocol address of the first at least one multifunction peripheral and the at least one service.

16. The apparatus of claim 15 further comprising:
a processor
a memory
wherein the processor and the memory comprise circuits and software for performing the instructions on the storage medium.

17. The apparatus of claim 15 wherein the instructions are further for periodically repeating the process at predetermined intervals.

18. The apparatus of claim 15 wherein the instructions are further for removing multifunction peripherals from the domain name server that are no longer responsive to discovery requests.

19. The apparatus of claim 15 wherein the series of mDNS discovery operations are at least in part passive and include listening for multifunction peripherals to broadcast their availability on each of the series of Internet protocol subnets.

20. The apparatus of claim 15 wherein the instructions are further for translating the device data into data suitable for storage in the domain name server.
